(19) United States
(12) Patent Application Publication
(10) Pub. No.: US 2007/0139099 A1
(43) Pub. Date: Jun. 21, 2007

(54) Charge pump regulation control for improved power efficiency

(75) Inventor: Feng Pan, San Jose, CA (US)

Correspondence Address: BEYER WEAVER & THOMAS, LLP, P.O. Box 778, Berkeley, CA, 94704-0778, US

(73) Assignee: SanDisk Corporation

(21) Appl. No.: 11/303,387

(22) Filed: Dec. 16, 2005

(51) Int. Cl. G05F 1/10

(52) U.S. Cl. 327/536

(57) ABSTRACT

Techniques for efficiently generating an output voltage for use within an electronic device, such as a memory system, are disclosed. A voltage generation circuit generates the output voltage. The voltage generation circuit includes regulation circuitry that controls regulation of the output voltage to maintain the output voltage at a substantially constant level. According to one aspect, regulation is enabled when needed but disabled when regulation is not necessary, thereby reducing power consumption by the regulation circuitry. The voltage generation circuit is therefore able to operate with improved power efficiency.

### CROSS REFERENCE TO RELATED APPLICATIONS

This application is related to U.S. patent application Ser. No. ______, entitled “VOLTAGE REGULATION WITH ACTIVE SUPPLEMENTAL CURRENT FOR OUTPUT STABILIZATION”, and filed concurrently herewith, and which is hereby incorporated by reference herein.

### BACKGROUND OF THE INVENTION

1. Field of the Invention

The invention relates to voltage generation and, more particularly, to voltage generation internal to memory systems.

2. Description of the Related Art

Memory cards are commonly used to store digital data for use with various products (e.g., electronics products). Examples of memory cards are flash cards that use Flash type or EEPROM type memory cells to store the data. Flash cards have a relatively small form factor and have been used to store digital data for products such as cameras, hand-held computers, set-top boxes, hand-held or other small audio players/recorders (e.g., MP3 devices), and medical monitors. A major supplier of flash cards is SanDisk Corporation of Sunnyvale, Calif.

FIG. 1 is a schematic diagram of a conventional voltage generation circuit 100. The conventional voltage generation circuit 100 can provide one or more generated voltages to a memory system that provides non-volatile data storage and represents, for example, a memory card (e.g., flash card). The voltage generation circuit 100 includes a charge pump circuit 102. The charge pump circuit 102 operates to boost a lower input voltage (V_{IN}) to produce a higher output voltage (V_{OUT}). The output voltage is coupled to a decoupling capacitor (CD) 104. The output voltage is also coupled to a resistor divider 106. The resistor divider 106 divides the output voltage using resistors R₁ and R₂. A comparator 108 couples to the resistor divider 106 and to a reference voltage (V_{REF}). The output of the comparator 108 is fed back to the charge pump circuit 102 so that the charge pump circuit 102 can regulate the output voltage so that it remains at a substantially constant voltage level.

Unfortunately, however, the constant regulation of the output voltage for the charge pump circuit 102 consumes a substantial amount of power. The power consumed by the constant regulation is particularly problematic when being used with power conscious electronic devices, such as battery-powered electronic devices. Accordingly, there is a need for improved voltage generation circuits that can operate with improved power efficiency.

### SUMMARY OF THE INVENTION

Broadly speaking, the invention relates to techniques for efficiently generating an output voltage for use within an electronic device, such as a memory system providing data storage. A voltage generation circuit generates the output voltage. The voltage generation circuit includes regulation circuitry that controls regulation of the output voltage to maintain the output voltage at a substantially constant level. According to one aspect of the invention, regulation is enabled when needed but disabled when regulation is not necessary, thereby reducing power consumption by the regulation circuitry. The voltage generation circuit is therefore able to operate with improved power efficiency.

The voltage generation circuit is particularly well suited for use in a memory product. For example, the voltage generation circuit can be provided within a portable data storage device (e.g., memory card) to generate an internal voltage.

The invention can be implemented in numerous ways, including as a method, system, device or apparatus. Several embodiments of the invention are discussed below.

A voltage generation circuit according to one embodiment of the invention includes at least: a charge pump circuit that receives an input voltage and outputs an output voltage at an output terminal, the output voltage being greater than the input voltage, and the charge pump circuit having a control terminal; a switch operatively connected to the output terminal of the charge pump circuit; and a feedback circuit operatively connected to the switch and to the control terminal of the charge pump circuit, the feedback circuit providing a feedback signal that is supplied to the control terminal of the charge pump circuit. The switch serves to enable or disable operation of the feedback circuit.

A voltage generation circuit according to another embodiment of the invention includes at least: a charge pump circuit that receives an input voltage and outputs an output voltage at an output terminal, the output voltage being greater than the input voltage, and the charge pump circuit having a control terminal; a switch operatively connected to the output terminal of the charge pump circuit; a resister divider operatively connected to the switch to provide a divided voltage; and a comparator operatively connected to the resister divider and to a reference voltage, the comparator comparing the divided voltage to the reference voltage to produce a first control signal that is supplied to the control terminal of the charge pump circuit.

A voltage generation circuit according to still another embodiment of the invention includes at least: a charge pump circuit that receives an input voltage and outputs an output voltage at an output terminal, the output voltage being greater than the input voltage, and the charge pump circuit having a control terminal; a switch operatively connected to a ground terminal; a resister divider operatively connected to the switch and to the output terminal of the charge pump circuit, the resister divider providing a divided voltage, the divided voltage being less than the output voltage from the charge pump circuit; and a comparator operatively connected to the resister divider and to a reference voltage, the comparator comparing the divided voltage to the reference voltage to produce a first control signal that is supplied to the control terminal of the charge pump circuit.

A voltage generation circuit according to still yet another embodiment of the invention includes at least: a charge pump circuit that receives an input voltage and outputs an output voltage at an output terminal, the output voltage being greater than the input voltage, and the charge pump circuit having a control terminal; and switchable feedback means for providing a feedback signal that is supplied to the control terminal of the charge pump circuit based on the output voltage at the output terminal of the charge pump circuit. The switching of the switchable feedback means operates to enable or disable regulation of the output voltage by the charge pump circuit, and the voltage generation circuit operates with a substantially reduced power when the regulation of the output voltage is disabled.

A memory product according to one embodiment of the invention including at least: data storage elements; a controller for performing data storage and retrieval with respect to the data storage elements; and at least one voltage generation circuit. The voltage generation circuit includes at least: a charge pump circuit that receives an input voltage and outputs an output voltage at an output terminal, the output voltage being greater than the input voltage, and the charge pump circuit having a control terminal; a switch operatively connected to the output terminal of the charge pump circuit; and a feedback circuit operatively connected to the switch and to the control terminal of the charge pump circuit, the feedback circuit providing a feedback signal that is supplied to the control terminal of the charge pump circuit, the switch serving to enable or disable operation of the feedback circuit.

An electronic system according to one embodiment of the invention including at least: a data acquisition device; and a data storage device removably coupled to the data acquisition unit. The data storage device stores data acquired by the data acquisition device, and the data storage device includes at least: data storage elements; a controller for performing data storage and retrieval with respect to the data storage elements; and at least one voltage generation circuit. The voltage generation circuit includes at least: a charge pump circuit that receives an input voltage and outputs an output voltage at an output terminal, the output voltage being greater than the input voltage, and the charge pump circuit having a control terminal; a switch operatively connected to the output terminal of the charge pump circuit; and a feedback circuit operatively connected to the switch and to the control terminal of the charge pump circuit, the feedback circuit providing a feedback signal that is supplied to the control terminal of the charge pump circuit, the switch serving to enable or disable operation of the feedback circuit.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like structural elements, and in which:

FIG. 1 is a schematic diagram of a conventional voltage generation circuit.

FIG. 2 is a schematic diagram of a voltage generation circuit according to one embodiment of the invention.

FIG. 3 is a block diagram of a memory system according to one embodiment of the invention.

FIG. 4A is a schematic diagram of a voltage generation circuit according to another embodiment of the invention.

FIG. 4B is a schematic diagram of a voltage generation circuit according to still another embodiment of the invention.

FIG. 5A is a graph illustrating a representative output voltage (V_{OUT}) from a voltage generation circuit according to one embodiment of the invention.

FIG. 5B illustrates a representative control signal (CNTL) that can be used to control a switch to activate or deactivate voltage regulation.

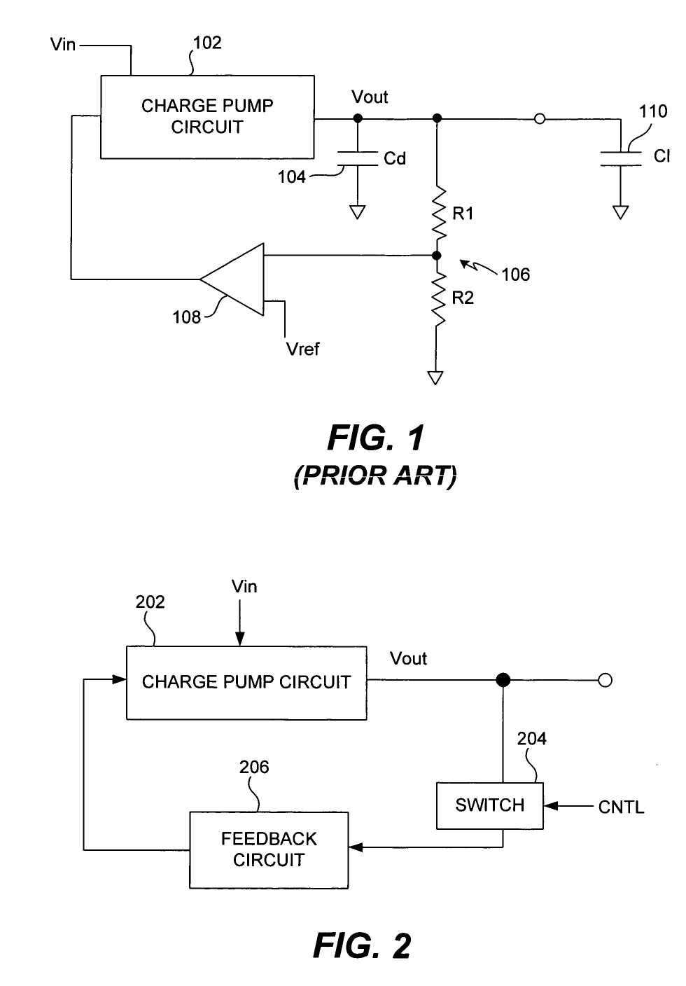

### DETAILED DESCRIPTION OF THE INVENTION

The invention relates to techniques for efficiently generating an output voltage for use within an electronic device, such as a memory system providing data storage. A voltage generation circuit generates an output voltage. The voltage generation circuit includes regulation circuitry that controls regulation of the output voltage to maintain the output voltage at a substantially constant level. According to one aspect of the invention, regulation is enabled when needed but disabled when regulation is not necessary, thereby reducing power consumption by the regulation circuitry. The voltage generation circuit is therefore able to operate with improved power efficiency.

The voltage generation circuit is particularly well suited for use in a memory product. For example, the voltage generation circuit can be provided within a portable data storage device (e.g., memory card) to generate an internal voltage.

Embodiments of this aspect of the invention are discussed below with reference to FIGS. 2-5B. However, those skilled in the art will readily appreciate that the detailed description given herein with respect to these figures is for explanatory purposes as the invention extends beyond these limited embodiments.

FIG. 2 is a schematic diagram of a voltage generation circuit 200 according to one embodiment of the invention. The voltage generation circuit 200 includes a charge pump circuit 202. The charge pump circuit 202 receives a lower input voltage (V_{IN}) and outputs a higher output voltage (V_{OUT}). The voltage generation circuit 200 also includes regulation circuitry (or feedback circuitry). in this embodiment, the regulation circuitry includes a switch 204 and a feedback circuit 206. The switch 204 is coupled in between the feedback circuit 206 and the output voltage (V_{OUT}) from the charge pump circuit 202. The switch 204 operates under the control of a control signal (CNTL). In particular, the control signal (CNTL) determines whether the switch 204 provides the output voltage (V_{OUT}) to the feedback circuit 206, or whether the switch 204 isolates the feedback circuit 206 from the output voltage (V_{OUT}). In one embodiment, the switch 204 is an active electronic device. For example, the switch 204 is or includes a transistor.

When the switch 204 operates to isolate the feedback circuit 206 from receiving the output voltage (V_{OUT}), the feedback circuit 206 becomes ineffective. In other words, in such case, the feedback circuit 206 does not participate in the regulation of the output voltage (V_{OUT}) by the charge pump circuit 202. Advantageously, when the switch 204 is controlled to isolate the feedback circuit 206 from the output voltage (V_{OUT}), the power consumed or dissipated by the feedback circuit 206 is substantially reduced (or even eliminated). Accordingly, the voltage generation circuit 200 is capable to operate with substantially improved power efficiency. Additionally, when the switch 204 does isolate the feedback circuit 206 from the output voltage (V_{OUT}), the charge pump circuit 202 is also disabled so that charge is not being pumped while the feedback circuit 206 is disabled, such that the output of the charge pump is left floating.

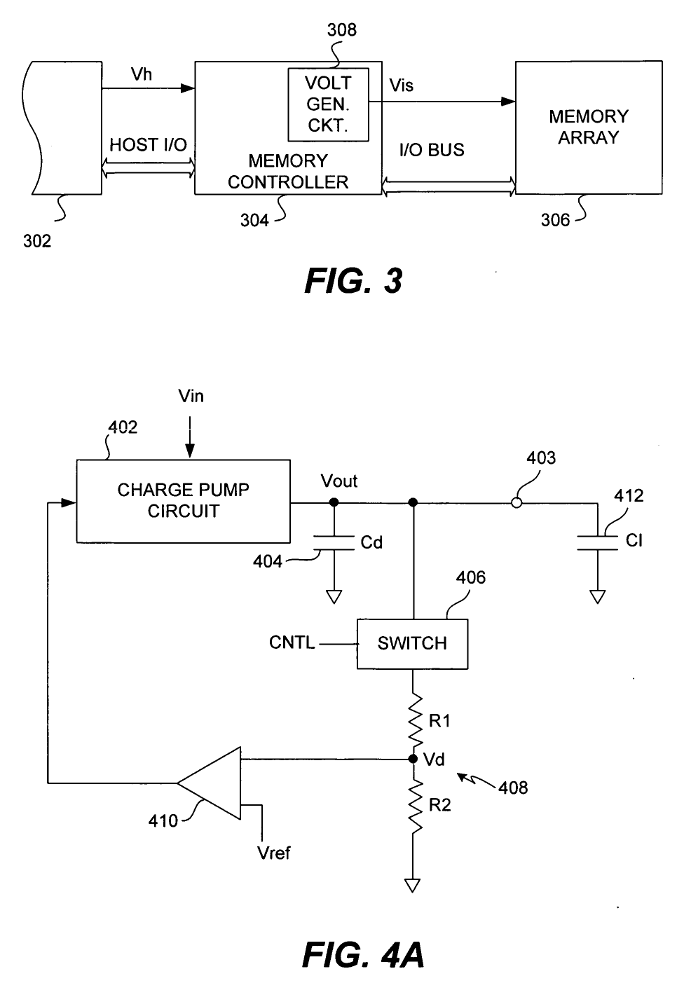

FIG. 3 is a block diagram of a memory system 300 according to one embodiment of the invention. The memory system 300 is, for example, associated with a memory card (such as a plug-in card), a memory stick, or some other data storage product. Examples of a memory card include PC Card (formerly PCMCIA device), Flash Card, Flash Disk, Multimedia Card, and ATA Card. The memory system 300 can also be referred to as a memory product or a removable data storage product.

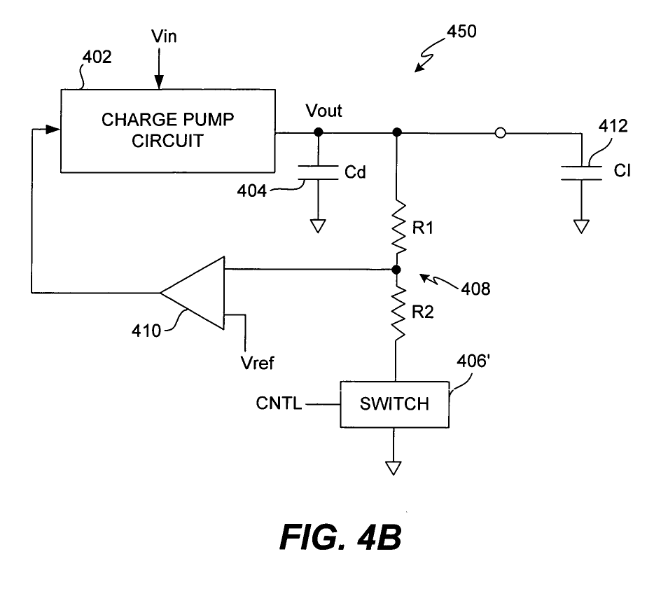

The memory system 300 cooperates with a host 302. For example, the host 302 can be a computing device, such as a personal computer. In particular, the memory system 300 stores data that can be utilized by the host 302. The memory system 300 and the host 302 can communicate over a host Input/Output (I/O) bus. The host 302 provides a host voltage (V_{H}) (i.e., supply voltage) to the memory system 300. The memory controller 304 couples to the host I/O bus and the host voltage (V_{H}). The memory controller 304 couples to a memory array 306 using an I/O bus and an internal supply voltage (V_{IS}). The internal supply voltage (V_{IS}) is generated by a voltage generation circuit 308 provided within the memory controller 304. The voltage generation circuit 308 can correspond to any of the voltage generation circuits discussed herein. For example, the voltage generation circuit 308 can correspond to the voltage generation circuits illustrated in FIGS. 2, 4A or 4B.

The level of the voltages can vary with implementation. As one example, the host voltage (V_{H}) might be 3.3 or 1.8 volts, and the level of the internal supply voltage (V_{IS}) might be 6.5 volts, 15 volts or 30 volts. Moreover, although the voltage generation circuit 308 is illustrated in FIG. 3 as being internal to the memory controller 304, in alternative embodiment, the voltage generation circuit 308 can be (i) internal to the memory array 306 or (ii) separate from either the memory controller 304 or the memory array 306.

The memory array 306 provides an array of data storage elements that provide non-volatile digital data storage. In one embodiment, the data storage elements are electrically programmable and electrically erasable, such as EEPROM or FLASH devices. For example, the data storage elements can be based on floating-gate devices. The memory array 306 can include one or more semiconductor dies, chips or products. The memory array 306 can include data storage elements. The memory controller 304 is also often a separate semiconductor die, chip or product.

Although the embodiment of the memory system 300 shown in FIG. 3 produces the internal supply voltage (V_{IS}) at the memory controller 304, it should be understood that the memory controller 304 can produce any number of a plurality of different supply voltage levels that would be needed by the memory array 306.

FIG. 4A is a schematic diagram of a voltage generation circuit 400 according to another embodiment of the invention. The voltage generation circuit 400 includes a charge pump circuit 402. The charge pump circuit 402 receives a low input voltage (V_{IN}) which is boosted to output a high output voltage (V_{OUT}) at an output terminal 403. A decoupling capacitor 404 couples the output terminal of the charge pump circuit 402 to ground. A switch 406 couples the output terminal 403 of the charge pump circuit 402 to a resistor divider 408. In one embodiment, the switch 406 can be implemented as a transistor, such as a high-voltage MOSFET. In one example, the switch 406 can be a high voltage PMOS device (with level shifted gate input that can turn on and off based on input). In another example, the switch 406 can be a high voltage NMOS device (with boosted gate voltage when turned on and zero volts when turned off). The resistor divider 408 includes resistors R1 and R2 connected in series. The switch 406 operates under the control of a control signal (CNTL). The resistor divider 408 produces a divided voltage (V_{D}) that is supplied to a first input terminal of a comparator 410. A second input terminal of the comparator 410 receives a reference voltage (V_{REF}). The output of the comparator 410 is a signal, namely, a control signal, that is fed back to the charge pump circuit 402. The control signal is utilized by the charge pump circuit 410 to regulate the output voltage (V_{OUT}) such that it is maintained at the specified voltage level plus or minus some permitted tolerance. In one embodiment, the switch 406, the resister divider 408 and the comparator 410 can be considered regulation circuitry used to regulate the output voltage (V_{OUT}). In another embodiment, the resister divider 408 and the comparator 410 can be considered regulation circuitry used to regulate the output voltage (V_{OUT}). Also, when in use, a load is coupled to the output terminal 403 of the voltage generation circuit 400. The load has a capacitance represented as a load capacitor 412. In other words, the load capacitor 412 represents the capacitance associated with the load that is coupled to the voltage generation circuit 400.

When the switch 406, under the control of a control signal (CNTL), serves to couple the resistor divider 408 to the output terminal 403 on the charge pump circuit 402, the voltage generation circuit 400 operates to produce and regulate the output voltage (V_{OUT}) by feeding back the control signal to the charge pump circuit 402.

On the other hand, when the switch 406 operates under the control of the control signal (CNTL) to isolate the resistor divider 408 from the output terminal 403, the output voltage (V_{OUT}) is not coupled to the resister divider 408. As a result, there is essentially no current flowing through the resister divider 408 to ground. Consequently, the voltage generation circuit 400 ceases regulating the output voltage (V_{OUT}), such that the control signal from the comparator 410 is not operational. In such case, since the resistor divider 408 tends to include substantial resistance values (e.g., 1 MOhms (10⁶ Ohms)), the power being consumed by the resistor divider 408 during regulation is essentially eliminated. Consequently, the power efficiency of the voltage generation circuit 400 is substantially improved when voltage regulation is not required. The charge pump circuit 402 is also normally disabled (e.g., with its output floating) when the switch 406 isolates the resistor divider 408 from the output terminal 403.

FIG. 4B is a schematic diagram of a voltage generation circuit 450 according to still another embodiment of the invention. The voltage generation circuit 450 is generally similar to the voltage generation circuit 400 illustrated in FIG. 4A. However, the voltage generation circuit 450 includes a switch 406′ that is placed between the resistor divider 408 and ground. The voltage generation circuit 450 operates similar to the voltage generation circuit 400. However, when the switch 406′ isolates the resister divider 408 from ground, there is essentially no current flowing through the resister divider 408. Consequently, the voltage generation circuit 450 ceases regulating the output voltage (V_{OUT}), such that the control signal from the comparator 410 is not operational. In this embodiment, the switch 406′ gate control can be at supply level to turn on and zero volts to turn off. When turned off, a relatively high voltage can be present at the switch 406′ which should be designed to handle such high voltage. Hence, the switch 406′ can be a high voltage switching device, such as a high-voltage MOSFET (e.g., high-voltage NMOS).

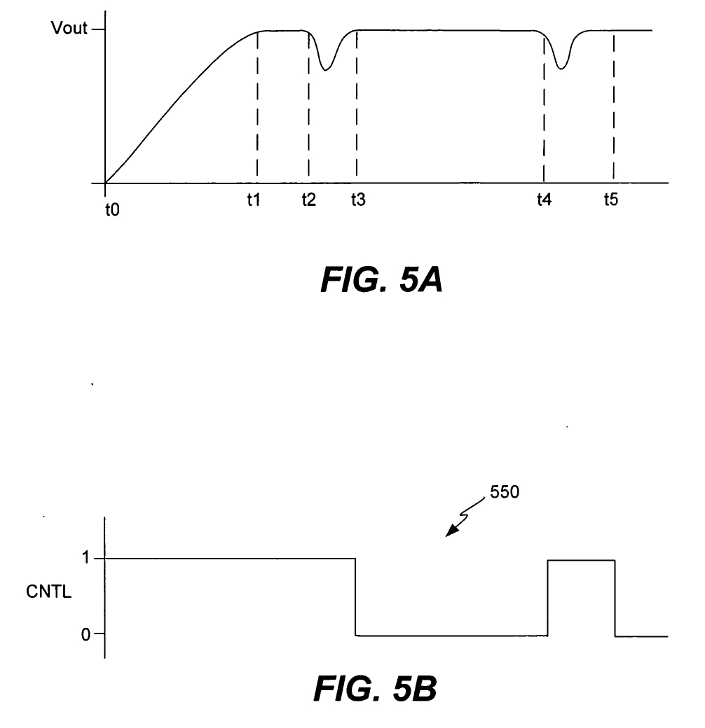

FIG. 5A is a graph 500 illustrating a representative output voltage (V_{OUT}) from a voltage generation circuit according to one embodiment of the invention. The output voltage at time t0 is zero (0) Volts indicating that the voltage generation circuit is initially off. The voltage generation circuit is enabled at time t0 but takes a duration of time to boost its output voltage to its predetermined level. Hence, at time t1, the output voltage has reached the predetermined level. Therefore, load circuitry that is to utilize the output voltage can be initiated. In one embodiment, the load circuitry performs an operation over a period of time. For example, when the load is a memory device, the operation can be a program operation to store data to the memory device. At time t2, the operation is initiated and draws a substantial amount of current from the output of the voltage generation circuit, thus causing the output voltage to drop (i.e., dip downward from the predetermined level). Through regulation of the output voltage, the voltage generation circuit responds to the voltage drop to return the output volt level back to the predetermined level at time t3. At this point, even though the operation is still in progress and the load is still connected to the output voltage, the current being drawn from the output of the voltage generation circuit is minimal between times t3 and t4. After time t3, it is not until t4 that the operation in progress next imposed a substantial current draw on the output of the voltage generation circuit. Hence, according to the invention, between times t3 and t4 the regulation of the output voltage can be deactivated (i.e., disabled) to reduce power consumption. At time t4, the regulation of the output voltage is again activated to return the output voltage level back to the predetermined level at time t5.

FIG. 5B illustrates a representative control signal (CNTL) 500 that can be used to control a switch (e.g., switch 406) to activate or deactivate voltage regulation. The control signal (CNTL) operates to deactivate voltage regulation during the time period between t3 and t4 shown in FIG. 5A. During this window of time from t3 to t4, the load on the output voltage produced by the voltage generation circuit is very low. In one implementation, the primary current drawn during the window of time from t3 to t4 is associated with leakage current associated with semiconductor structures associated with the load on the output voltage for the voltage generation circuit. Typically, the leakage current is rather small and can be estimated. As result, the control signal (CNTL) can operate to disable the voltage regulation for a limited period of time, i.e., between t3 to t4. When the voltage regulation is disabled, the current drawn due to regulation of the output voltage level of the voltage generation circuit is completely or substantially eliminated. However, given the presence of at least the leakage current, the control signal (CNTL) should only disable the voltage regulation for a limited period of time. This limited period of time can be empirically determined such that the output voltage does not substantially drop from its predetermined level. The limited period of time is dependent on the leakage current (and perhaps a small load current) and the permitted voltage drop on the output voltage. In other words, the control signal (CNTL) is dependent on the amount of current being drawn by leakage and/or the load on the output terminal of the charge pump circuit.

The invention is suitable for use with both single-level memories and multi-level memories. The memories or memory blocks are data storage devices that include data storage elements. The data storage elements can be based on semiconductor devices (e.g., floating-gate) or other types of devices. In multi-level memories, each data storage element stores two or more bits of data.

The invention can further pertain to an electronic system that includes a memory system as discussed above. Memory systems (i.e., memory cards) are commonly used to store digital data for use with various electronics products. The memory system is often removable from the electronic system so the stored digital data is portable. The memory systems according to the invention can have a relatively small form factor and be used to store digital data for electronics products that acquire data, such as cameras, hand-held or notebook computers, network cards, network appliances, set-top boxes, hand-held or other small media (e.g., audio) players/recorders (e.g., MP3 devices), and medical monitors.

The advantages of the invention are numerous. Different embodiments or implementations may yield one or more of the following advantages. One advantage of the invention is that voltage regulation for charge pumps can be provided in a power efficient manner. Another advantage of the invention is that regulation of an output voltage level can be temporarily disabled when current being drawn is low. Still another advantage of the invention is that low power, reliable, high performance memory systems can be obtained.

The many features and advantages of the present invention are apparent from the written description and, thus, it is intended by the appended claims to cover all such features and advantages of the invention. Further, since numerous modifications and changes will readily occur to those skilled in the art, it is not desired to limit the invention to the exact construction and operation as illustrated and described. Hence, all suitable modifications and equivalents may be resorted to as falling within the scope of the invention.

What is claimed is:

1. A voltage generation circuit, comprising:
a charge pump circuit that receives an input voltage and outputs an output voltage at an output terminal, the output voltage being greater than the input voltage, and the charge pump circuit having a control terminal;
a switch operatively connected to the output terminal of the charge pump circuit; and
a feedback circuit operatively connected to the switch and to the control terminal of the charge pump circuit, the feedback circuit providing a feedback signal that is supplied to the control terminal of the charge pump circuit,
wherein the switch serves to enable or disable operation of the feedback circuit.

2. A voltage generation circuit as recited in claim 1, wherein the voltage generation circuit operates with substantially reduced power when the feedback circuit is disabled by the switch.

3. A voltage generation circuit as recited in claim 1, wherein the switch is controlled by a control signal to enable the feedback circuit when regulation of the output voltage of the charge pump circuit is needed.

4. A voltage generation circuit as recited in claim 3, wherein a load is coupled to the output terminal of the charge pump circuit, and
wherein the control signal is dependent on an amount of current being drawn by the load on the output terminal of the charge pump circuit.

5. A voltage generation circuit as recited in claim 1, wherein regulation of the output voltage of the charge pump circuit is disabled when the feedback circuit is disabled by the switch.

6. A voltage generation circuit as recited in claim 1, wherein the switch includes at least a transistor.

7. A voltage generation circuit as recited in claim 1, wherein the voltage generation circuit further comprises:
a decoupling capacitor operatively connected to the output terminal of the charge pump circuit.

8. A voltage generation circuit as recited in claim 1, wherein the voltage generation circuit produces the output voltage for use in a memory product.

9. A voltage generation circuit as recited in claim 1, wherein the memory product is a FLASH memory device.

10. A voltage generation circuit, comprising:
a charge pump circuit that receives an input voltage and outputs an output voltage at an output terminal, the output voltage being greater than the input voltage, and the charge pump circuit having a control terminal;
a switch operatively connected to the output terminal of the charge pump circuit;
a resister divider operatively connected to the switch to provide a divided voltage; and
a comparator operatively connected to the resister divider and to a reference voltage, the comparator comparing the divided voltage to the reference voltage to produce a first control signal that is supplied to the control terminal of the charge pump circuit.

11. A voltage generation circuit as recited in claim 10, wherein the switch serves to prevent or substantially limit power consumption by the resister divider when the switch decouples the resister divider from the output terminal of the charge pump circuit.

12. A voltage generation circuit as recited in claim 10, wherein when the switch decouples the resister divider from the output terminal of the charge pump circuit, the first control signal from the comparator disables regulation of the output voltage by the charge pump circuit.

13. A voltage generation circuit as recited in claim 12, wherein when the switch couples the resister divider from the output terminal of the charge pump circuit, the first control signal from the comparator enables regulation of the output voltage by the charge pump circuit.

14. A voltage generation circuit as recited in claim 10, wherein the voltage generation circuit further comprises:
a decoupling capacitor operatively connected to the output terminal of the charge pump circuit.

15. A voltage generation circuit as recited in claim 10, wherein the switch is controlled by a second control signal to enable the feedback circuit when regulation of the output voltage of the charge pump circuit is needed.

16. A voltage generation circuit as recited in claim 15, wherein a load is coupled to the output terminal of the charge pump circuit, and
wherein the second control signal is dependent on an amount of current being drawn by the load on the output terminal of the charge pump circuit.

17. A voltage generation circuit as recited in claim 10, wherein regulation of the output voltage of the charge pump circuit is disabled when the switch decouples the resister divider from the output terminal of the charge pump circuit.

18. A voltage generation circuit as recited in claim 10, wherein the switch includes at least a transistor.

19. A voltage generation circuit, comprising:
a charge pump circuit that receives an input voltage and outputs an output voltage at an output terminal, the output voltage being greater than the input voltage, and the charge pump circuit having a control terminal;
a switch operatively connected to a ground terminal;
a resister divider operatively connected to the switch and to the output terminal of the charge pump circuit, the resister divider providing a divided voltage, the divided voltage being less than the output voltage from the charge pump circuit; and
a comparator operatively connected to the resister divider and to a reference voltage, the comparator comparing the divided voltage to the reference voltage to produce a first control signal that is supplied to the control terminal of the charge pump circuit.

20. A voltage generation circuit, comprising:
a charge pump circuit that receives an input voltage and outputs an output voltage at an output terminal, the output voltage being greater than the input voltage, and the charge pump circuit having a control terminal; and
switchable feedback means for providing a feedback signal that is supplied to the control terminal of the charge pump circuit based on the output voltage at the output terminal of the charge pump circuit,
wherein switching of the switchable feedback means operates to enable or disable regulation of the output voltage by the charge pump circuit, and
wherein the voltage generation circuit operates with substantially reduced power when the regulation of the output voltage is disabled.

21. A memory product, comprising:
data storage elements;
a controller for performing data storage and retrieval with respect to the data storage elements; and
at least one voltage generation circuit, the voltage generation circuit comprising:
a charge pump circuit that receives an input voltage and outputs an output voltage at an output terminal, the output voltage being greater than the input voltage, and the charge pump circuit having a control terminal;
a switch operatively connected to the output terminal of the charge pump circuit; and
a feedback circuit operatively connected to the switch and to the control terminal of the charge pump circuit, the feedback circuit providing a feedback signal that is supplied to the control terminal of the charge pump circuit, the switch serving to enable or disable operation of the feedback circuit.

22. A memory product as recited in claim 21, wherein the memory product is a memory card.

23. A memory product as recited in claim 21, wherein the data storage elements provide non-volatile data storage.

24. A memory product as recited in claim 21, wherein the data storage elements provide semiconductor-based data storage.

25. A memory product as recited in claim 24, wherein the data storage elements are EEPROM or FLASH.

26. A memory product as recited in claim 21, wherein each of the data storage elements comprise at least one floating-gate storage device.

27. A memory product as recited in claim 21, wherein the memory system is a removable data storage product.

28. A memory product as recited in claim 21, wherein the memory product is removably coupled to a host.

29. A memory system as recited in claim 28, wherein the host is a computing device.

30. An electronic system, comprising:
a data acquisition device; and
a data storage device removably coupled to the data acquisition unit, the data storage device storing data acquired by the data acquisition device, and the data storage device including at least:
data storage elements;
a controller for performing data storage and retrieval with respect to the data storage elements; and
at least one voltage generation circuit, the voltage generation circuit including at least:
a charge pump circuit that receives an input voltage and outputs an output voltage at an output terminal, the output voltage being greater than the input voltage, and the charge pump circuit having a control terminal;
a switch operatively connected to the output terminal of the charge pump circuit; and
a feedback circuit operatively connected to the switch and to the control terminal of the charge pump circuit, the feedback circuit providing a feedback signal that is supplied to the control terminal of the charge pump circuit, the switch serving to enable or disable operation of the feedback circuit.

31. An electronic system as recited in claim 30, wherein the data acquisition device is one of a camera, a network card or appliance, a hand-held or notebook computer, a set-top box, a hand-held or other small media player/recorder, and a medical monitor.
